(19) United States
(12) Patent Application Publication
(10) Pub. No.: US 2008/0279293 A1
(43) Pub. Date: Nov. 13, 2008

(54) Coded Orthogonal Frequency Division Multiplexing Method and Apparatus

(75) Inventors: Vasanth Gaddam, Tarrytown, NY (US); Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, Inc., Eindhoven (NL)

(21) Appl. No.: 12/091,560

(22) PCT Filed: Oct. 27, 2006
(86) PCT No.: PCT/IB06/53993

§ 371 Date: Apr. 25, 2008

Related U.S. Application Data
(60) Provisional application No. 60/730,976, filed on Oct. 28, 2005.

(51) Int. Cl. H04L 27/26; H04L 27/28

(52) U.S. Cl. 375/260; 375/308; 375/340

(57) ABSTRACT

A method and apparatus for transmitting and receiving data via guard tones are described. The information bits are coded by convolutional encoder (101) and some of the punctured bits from punctured (102) are selected with bit selector (105) and subject as the punctured data to interleaving by an interleaver (106-103 for the punctured data-). The OFDM process that follows (104, 107, 108) maps the interleaved selected punctured bits to guard tones and the interleved punctured data to data sub-carriers.

Ultra wideband (UWB) communications involve transmission of signals that occupy a large bandwidth. In a UWB system, a modulated signal is either transmitted as a base-band pulse (carrier-free transmission) or is converted (mixed) upward in frequency to a certain carrier frequency. Many UWB applications have been limited to radar and military communications. However, because of the potential for use of UWB technology in high data-rate, short range communications, the Federal Communications Commission (FCC) has provided the frequency band from 3.1 GHz to 10.6 GHz for unlicensed devices.

UWB communication systems transmit short-duration pulses of data over the transmission range referenced. As can be appreciated, because of the relatively short duration of the pulse in the time domain, the number of frequency components is quite large. This correlates to a relatively wide bandwidth signal. Accordingly, a properly designed UWB system provides transmission of a significant amount of data in relatively short time, making UWB systems rather attractive for high data-rate applications.

One technique for transmitting and receiving information in UWB systems is known as coded orthogonal frequency division multiplexing (COFDM). In a COFDM system, the frequency band is divided into sets of four sub-carriers. These are the data sub-carriers, pilot sub-carriers, guard tones and NULL tones. The number of data sub-carriers determines the data rate of the system, while the remaining three sets of sub-carriers are considered as overhead and are used for proper operation of the system.

The pilot sub-carriers are used to estimate and correct carrier phase offset. The guard tones, which are at the band edges, are usually specified to relax the transmitter/receiver filter specifications.

Coding is normally used with an OFDM system to improve system performance. The system can switch among different data rates based on user requirements and/or channel conditions. For example, in a rate-1/3 convolutional coding scheme, each information bit is transformed into three coded bits. The redundancy offers a measure of assurance that a transmitted information bit will be received at the receiver. Thereby, the throughput of the system is improved.

As can be appreciated, the redundancy provided by coding results in fewer information bits being transmitted, thereby reducing the data rate. Thus, there is a trade-off of accuracy and throughput in the transmission/reception of data. In an effort to increase the data sub-carrier transmission efficiency, certain coded bits are removed according to pre-determined patterns to achieve different coding rates. This is often referred to as puncturing and the removed bits are known as punctured bits. Of course, in known systems, eliminating this redundancy can reduce the likelihood that an information bit is received. As such, the reliability of the communication system may be compromised.

There is a need for a method and apparatus of COFDM that overcomes at least some of the shortcomings described above.

In an example embodiment, a method of transmitting data, the method includes coding an information bit into a plurality of coded bits; puncturing a select number of the coded bits and removing the select number of bits from a data path; mapping at least one of the removed select number of coded bits onto respective guard tones; and transmitting the guard tones.

In another example embodiment, an apparatus adapted to transmit data includes a coder adapted to code an information bit into a plurality of coded bits. The apparatus also includes a puncturer adapted to receive the plurality of coded bits and to remove a select number of the coded bits from a data path; and a bit selector adapted to select a group of the select number of the coded bits. In addition, the apparatus includes a mapping device adapted to map each bit of the group of bits to a respective guard tone.

The invention is best understood from the following detailed description when read with the accompanying drawing figures. Wherever practical, like reference numerals refer to like elements.

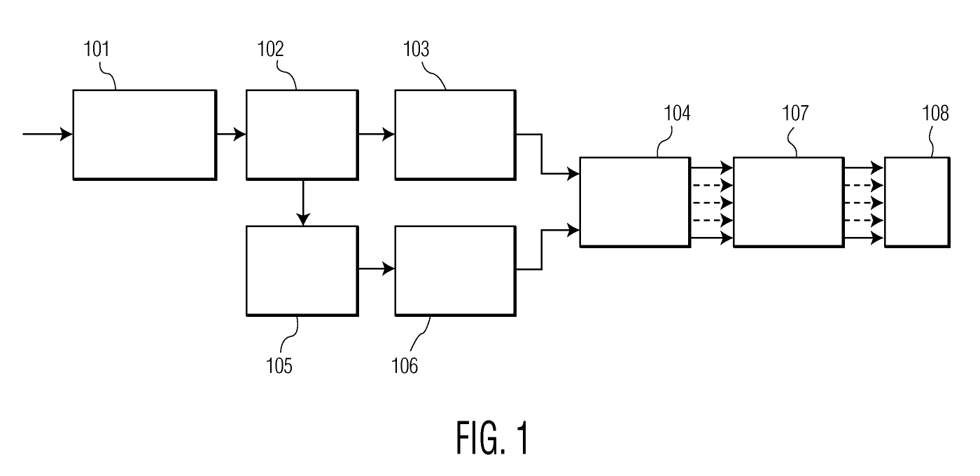

FIG. 1 is a simplified schematic diagram of a COFDM transmitter in accordance with an example embodiment.

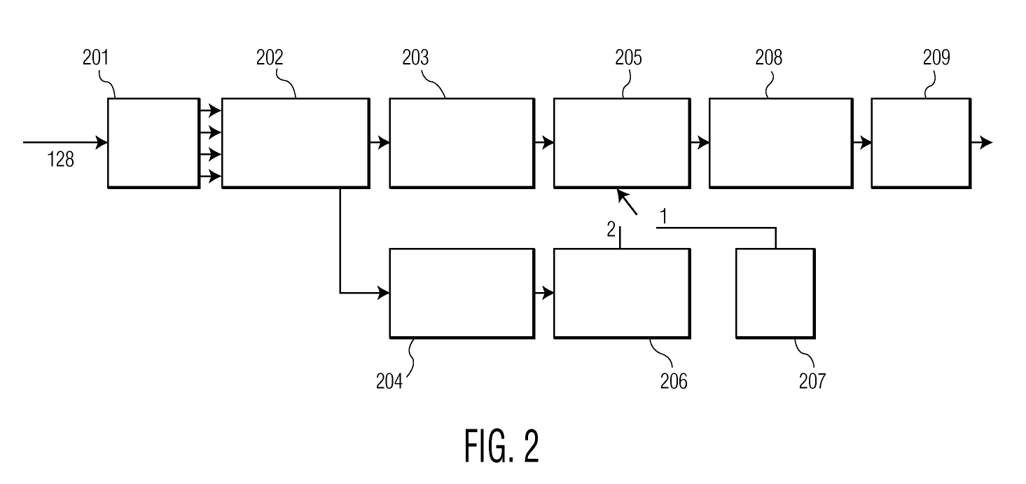

FIG. 2 is a simplified schematic diagram of a COFDM receiver in accordance with an example embodiment.

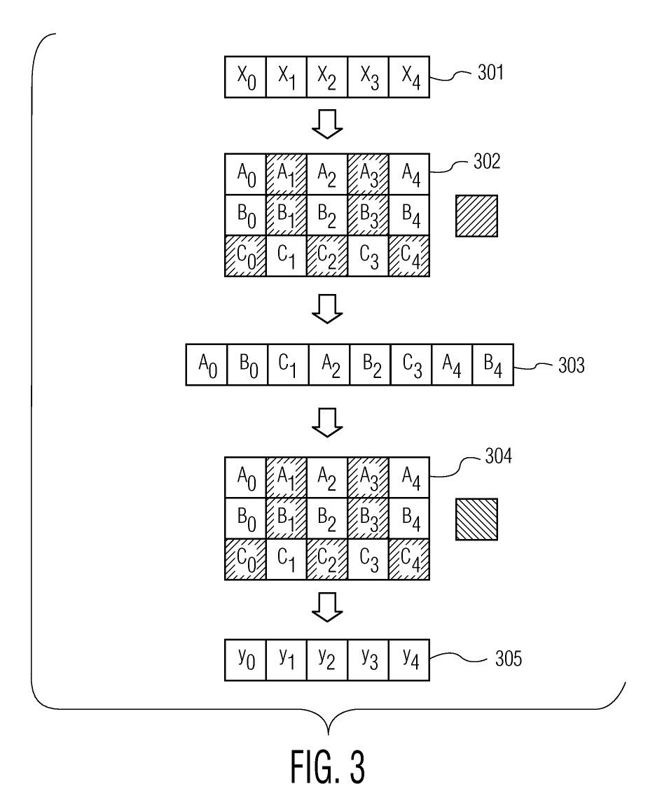

FIG. 3 is a conceptual diagram of a puncturing mechanism in accordance with an example embodiment.

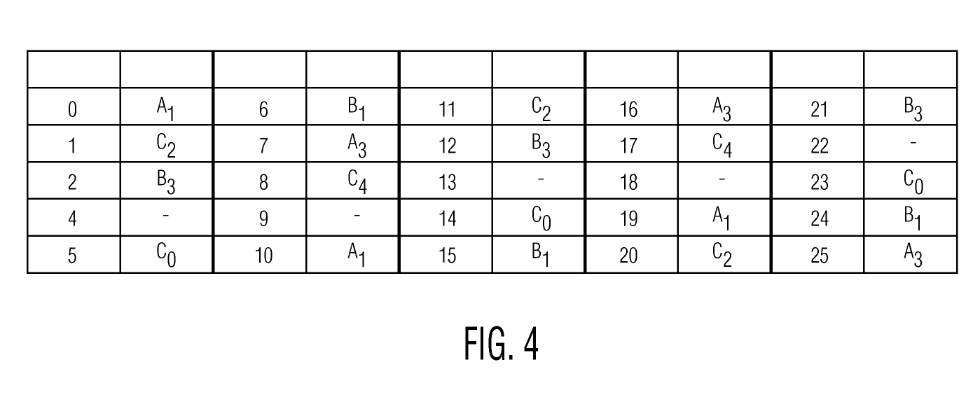

FIG. 4 is a tabular representation of punctured bits and selected bits in accordance with an example embodiment.

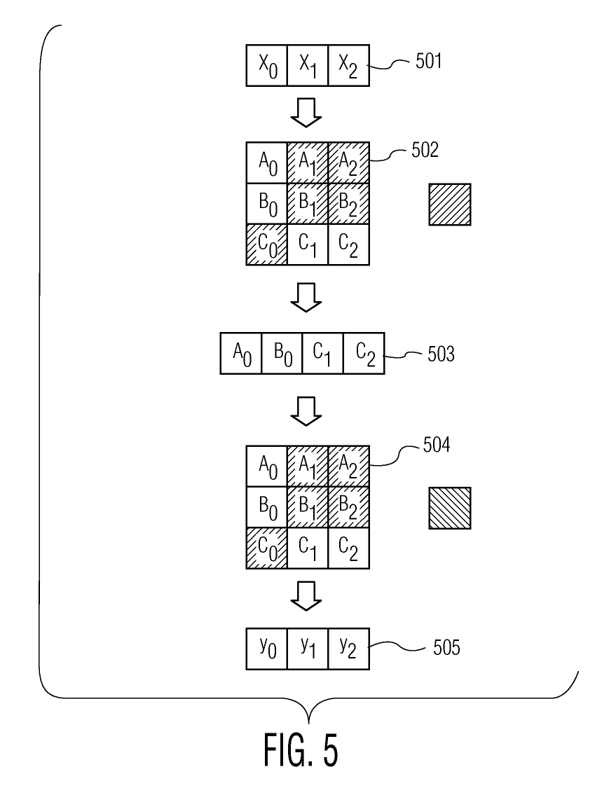

FIG. 5 is a conceptual diagram of a puncturing mechanism in accordance with an example embodiment.

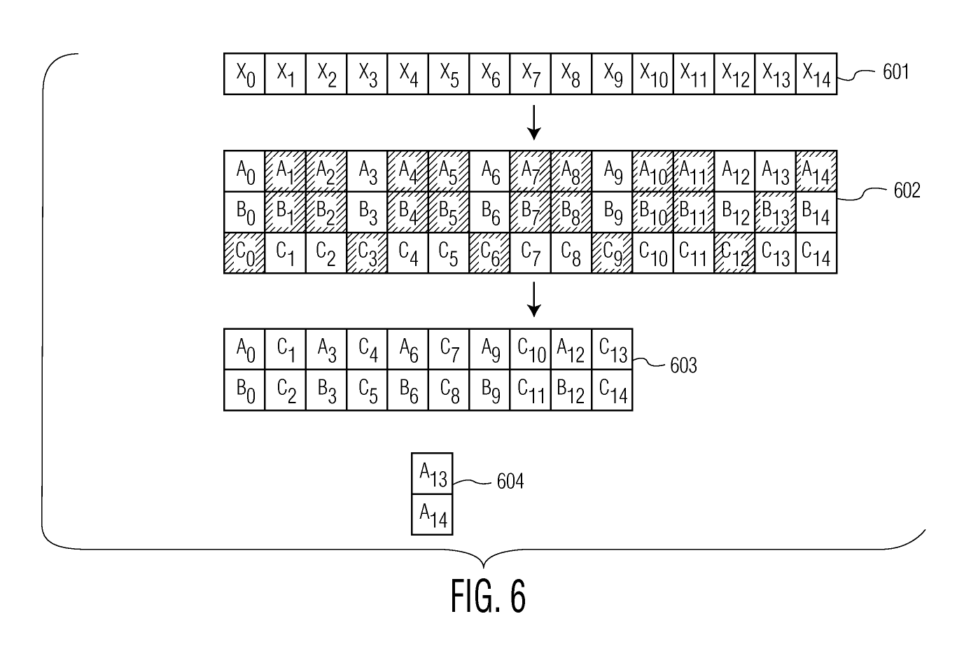

FIG. 6 is a conceptual diagram of a puncturing mechanism in accordance with an example embodiment.

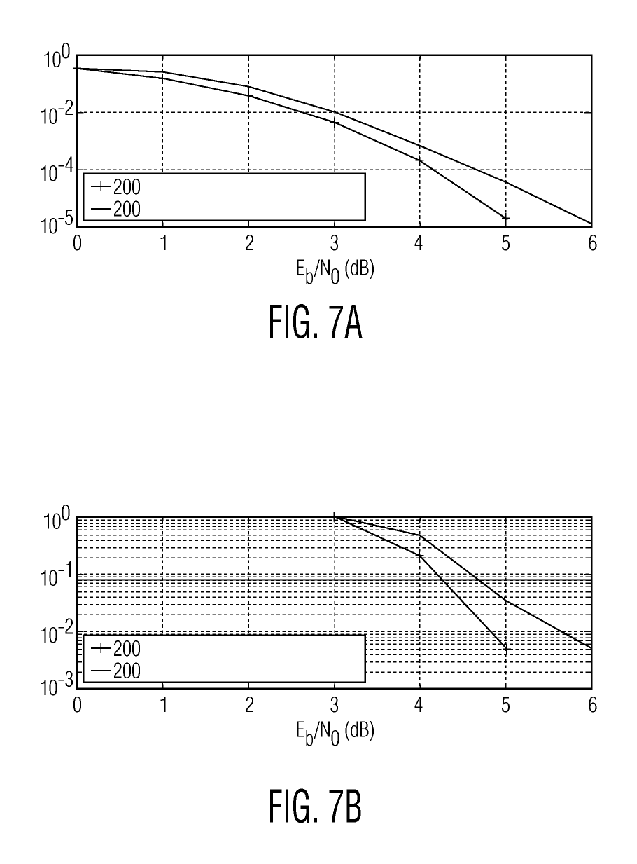

FIGS. 7A and 7B are graphical representations of the PER versus E_{b}/N_{b} and PER versus E_{b}/N_{b}, respectively, for a known COFDM system and a COFDM system of an example embodiment.

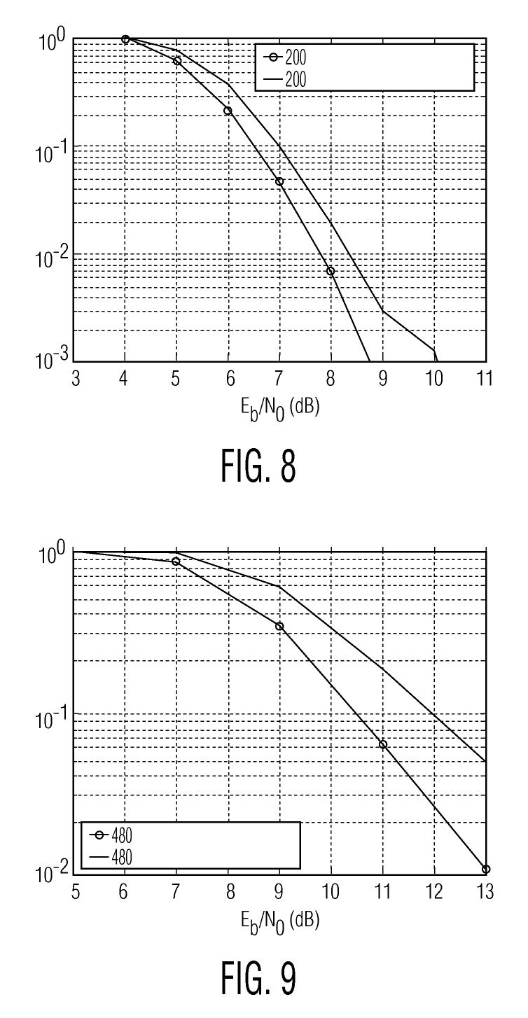

FIG. 8 is a graphical representation of the average PER versus E_{b}/N_{b} for a known COFDM system and a COFDM system of an example embodiment.

FIG. 9 is a graphical representation of the average PER versus E_{b}/N_{b} for a known COFDM system and a COFDM system of an example embodiment.

In the following detailed description, for purposes of explanation and not limitation, example embodiments disclosing specific details are set forth in order to provide a thorough understanding of the present teachings. However, it will be apparent to one having ordinary skill in the art having had the benefit of the present disclosure that other embodiments that depart from the specific details disclosed herein are contemplated. Moreover, descriptions of well-known devices, methods, systems and protocols may be omitted so as to not obscure the description of the example embodiments. Nonetheless, such devices, methods, systems and protocols that are within the purview of one of ordinary skill in the art may be used in accordance with the example embodiments.

FIG. 1 is a simplified schematic diagram of an OFDM apparatus for transmitting data in accordance with an example embodiment. In a specific embodiment, the OFDM apparatus is a component of a UWB wireless system, such as an MBOA UWB wireless system. However, the apparati and methods described in connection with the example embodiments are contemplated for use in other communication systems, such as other COFDM systems.

As described more fully herein, coding of the data is used with an OFDM system to improve system performance. The coded bits are punctured according to pre-determined patterns to achieve different coding rates. The system can switch among different data rates based on user requirements and/or channel conditions. In the illustrative embodiments, guard tones carry the some discarded coded data in a backward compatible manner. As described herein, systems of the example embodiments are designed with filters having a small transition width. This allows the use of guard tones carrying some of the discarded bits to improve the system performance. Notably, a legacy system that does not use such filters can discard the guard tones carrying punctured bits and still decode the received signal, albeit without the benefit of the data from the guard tones.

In the description that follows some components of the transmitter and receiver are defined in accordance with the MBOA Physical (PHY) Layer Specification version 1.0. Details of these known components are found in this specification, the disclosure of which is specifically incorporated herein by reference. However, certain aspects of these components may be modified in accordance with example embodiments. Moreover, additional components are used to realize the transmission and reception of data according to the example embodiments.

The apparatus includes a convolutional coder 101, which is illustratively a rate 1/3 convolutional code. Information bits are received by the coder 101 and are coded according to a chosen known convolutional coding technique. The coded bits are input to a puncturer 102 used to generate different code rates. To this end, the coder provides significant redundancy in an effort to ensure accuracy of the data at a receiver (not shown in FIG. 1). However, this redundancy results in the reduction of the data rate. As such, the puncturer 102 removes some of the coded bits according to a pre-defined pattern, allowing for other bits to be sent in an effort to improve the data rate. The punctured coded data from the puncturer 102 is then input to an interleaver 103. The interleaver 103 is useful in mitigating data errors from burst errors by interleaving data across subcarriers. The interleaved data are input to a spreader/mapper 104, which maps the data onto data subcarriers. Illustratively, there are 100 subcarriers that carry the data to receivers.

The punctured bits that are discarded at the puncturer 102 are input to a bit selector 105. As described in further detail herein, the bit selector 105 selects a predetermined set (referred to herein as recovered bits) of discarded punctured bits and provides them to an interleaver 106, which interleaves the bits in a manner similar to that of interleaver 103. Thereafter, the bits are transmitted to the spreader/mapper 104, mapped by constellational mapping and, if desired, spread using a known dual carrier spreading technique. In an embodiment, quadrature phase shift keying (QPSK) is used and thus two bits are mapped to each guard tone. In this embodiment, there are 10 guard tones so 20 recovered bits may be transmitted on the guard tones and for decoded for data reconstruction at the receiver. The output of the interleaver 103 is mapped on to 100 data sub-carriers and the output of interleaver 106 is mapped on to 10 guard tones. The output of the spreader/mapper 104 is then input to a pilot tone insertion block 107, where the 110 sub-carriers are combined with the pilot carriers.

Notably, in known MBOA transmitters, a p[o]ilot and guard tone insertion apparatus is used. This apparatus adds pilot and guard tones to the 100 data sub-carriers. In the present embodiment, since the guard tones are also used as data sub-carriers, only pilot tones need to be inserted. This is done at the pilot tone insertion block 107. In addition, NULL carriers are provided at block 107. The resultant array is then processed by an inverse fast Fourier transform (IFFT) block 108 to generate the OFDM signal for transmission.

The output of the interleaver 106 is modulated using QPSK modulation at a modulator included in the mapper/spreader 104. Alternatively, the modulation may be carried out by a constellational mapping device, well known to one skilled in the art. The stream of complex numbers (d) from the modulator is then divided into groups of 10 complex numbers g_{n,k}=d_{n+10×k}, where k is the symbol number, and n is the guard tone number.

In a specific embodiment, the mapping of the recovered bits to guard tones at the mapper/spreader 105 is defined by a function W(n). Apart from mapping the bits into symbols, the mapper/spreader 104 of the example embodiments also maps the symbols to specific indices in an array. The function W(n) determines this mapping.

The function map from the indices 0 to 10 to the logical frequency offset indices {−61, −60, . . . , −57} and {57, 58, . . . , 61}.

$$W ( n ) = \{ \begin{matrix}n - 61 & 0 \leq n \leq 4 \\ n + 52 & 5 \leq n \leq 9\end{matrix}$$

An OFDM symbol r_{data,k}(t) that is transmitted to receivers is defined as:

$${r}_{data , k} ( t ) = {p}_{mod ( k , 127 )} {\sum }_{n = - {N}_{ST} / 2}^{{N}_{ST} / 2} {P}_{n} exp ( j 2 π n {Δ}_{F} ( t - {T}_{CP} ) ) + {\sum }_{n = 0}^{{N}_{SD}} {c}_{n , k} exp ( j 2 π M ( n ) {Δ}_{F} ( t - {T}_{CP} ) ) + {\sum }_{n = 0}^{n = 9} {g}_{n , k} exp ( j 2 π W ( n ) {Δ}_{F} ( t - {T}_{CP} ) ) +$$

where N_{SD} is the number of data sub-carriers, Δ_{F} is the sub-carrier spacing and T_{CP} is the duration of the prefix. The first term in the above equation is the contribution from the pilot sub-carriers. The pilot sub-carriers are defined for n={±5, ±15, ±25, ±35, ±45, ±55} and are zero for all other values of n. The second term is the contribution from the data sub-carriers and the third term is the contribution from the guard tones.

FIG. 2 is a simplified schematic block diagram of a receiver in accordance with an example embodiment. As noted, many of the components of the receiver are known from the MBOA PHY layer specification and as such many details are omitted in order to avoid obscuring the description of the example embodiments. The OFDM symbols are received at a fast Fourier transformer (FFT) 201, which is illustratively a 128 point transformer. The output from the FFT 201 is input to a de-spreader and de-mapper block 202. The de-spreader/de-mapper 202 separates data, pilot and guard sub-carriers and re-organizes the data according to the MBOA PHY layer specification. In addition, the de-spreader/de-mapper also generates soft metrics for data bits.

The block 202 sends the soft metrics derived from the data sub-carriers to a main de-interleaver 203 and the soft metrics derived from the guard tones to a de-interleaver 204. As can be appreciated, the de-interleaver 204 is used only when the corresponding interleaver (e.g., interleaver 105) is used in the transmitter.

The output from the de-interleaver 203 is input to a main de-puncturer 205, the details of which are provided in the referenced MBOA PHY layer specification. The main de-puncturer 205 selects the output of a de-puncturer 206 for 20 punctured bit positions in each OFDM symbol and inserts zeroes (null bits) for the other punctured positions. To this end, the bit selector 105 does not transmit all of the punctured bits for inclusion in the guard tones. Therefore, null bits must be inserted in order to properly decode the coded bits. The number of null bits inserted by the de-puncturer 206 depends on the rate of transmission. The greater the data rate, the greater the number of punctured bits and the greater the number of null bits that need to be entered by the de-puncturer 206. In a specific embodiment, the de-puncturer 205 is connected to a ‘zeroes’ block 207 and the de-puncturer 205 will insert a null bit for each bit in the guard tones. This renders the receiver backward compatible for transmitters that are not adapted to include removed bits in the guard tones. Further details of the function of the de-puncturer 206 are provided in connection with the descriptions of FIGS. 3-6 below.

[0] In digital communications systems, filters are used to remove out-of-band signal components. In order to reduce the filter complexity, in known systems filters are often specified with a larger transition width from pass-band to stop-band. This results in the attenuation of the guard sub-carriers at the band edges. Therefore, in known systems reliable data cannot be carried in these sub-carriers. In the systems of the example embodiments, the transmitter and the receiver incorporate filters with a small transition width (sharp filters) allowing the guard sub-carriers to carry the coded bits. Notably, the sharp filters (not shown) receive the output of the IFFT 108. After filtering the transmission is completed. At the receiver, the filters are coupled to the FFT 201 and filter the received signal prior to the FFT 201.

However, if a transmitter of an example embodiment is used in connection with a receiver that does not have high-end frequency filtering capabilities; the guard tones are provided as null bits. Thereby legacy compatibility is preserved.

Certain examples are now provided to illustrate the adaptation of the example embodiments in an MBOA system. These examples are intended merely to illustrate the example embodiments and are in no-way limiting thereof.

In known MBOA systems, the 200 Mbps mode and 400 Mbps mode use a coding rate of ⅝. For these modes, the number of coded bits per OFDM symbol is equal to 200. FIG. 3 shows the puncturing and de-puncturing mechanism for these modes. The mechanism of FIG. 3 is best understood when reviewed in conjunction with the transmitter of FIG. 1 and the receiver of FIG. 2. Referring to FIG. 1, the encoder 101 operates on a source data block 301 having 5 bits and produces encoded data 302 of 15 bits. The puncturer 102 operates on the encoded data and provides an output data block 303 having 8 bits, with the shaded bits being removed. Therefore, in order to generate 200 coded bits corresponding to one OFDM symbol, the puncturer has to process 200/8=25 such blocks. The number of discarded bits due to puncturing in this mode is 7*25=175 for each symbol. The bit selector 105 can select 20 bits from the 175 discarded bits and map them on to the 10 guard tones.

The IFFT 108 transmits the bits of the output data block 303 on data sub-carriers, which are received at the receiver. After processing at the de-puncturer 205, null bits (shaded) are inserted for data reconstruction resulting in reconstructed bits 305. Thereafter, the decoder 208 decodes the data an provides decoded data 305 is provided.

Because only 20 bits of 175 bits (corresponding to 25 blocks) from the puncturer can be selected for transmission on the guard tones, at most only one bit may be selected from each block. FIG. 4 shows a pattern that can be used by the bit selector to select the removed bits that are mapped to the guard tones. Note that no bits are selected in block numbers 4, 9, 13, 18 and 22. The pattern is repeated every 25 blocks, or every OFDM symbol. At the receiver, data from the guard tones is used in the main de-puncturer instead of null bits for the bits that are transmitted on guard tones. It is noted that the pattern of FIG. 4 is merely illustrative and that other patterns may be chosen.

In an MBOA system transmitting in 480 Mbps mode, rate 3/4 coding is used. In this mode, the number of coded bits per OFDM symbol is equal to 200. FIG. 5 is a representative diagram of a puncturing and de-puncturing mechanism for this data rate in accordance with an example embodiment. In this mode, three bits of source data 501 are encoded by the convolutional coder 101 and provides a nine bit block 502. The puncturer 102 operates on the data block 502 and produces an output data block 503 comprising four bits. Therefore, in order to generate 200 coded bits corresponding to one OFDM symbol, the puncturer has to process 200/4=50 such blocks. The number of discarded bits due to puncturing in this mode is 5*50=250 for each symbol. The data block 503 is transmitted, received, deinterleaved, de-punctured and decoded as described above. Null bits are inserted to provide reconstructed data block 504 and the decoded data block 505 is output from the decoder 208.

In accordance with example embodiments, the guard tones transmit some of the coded bits that are removed through the puncturing process. In the MBOA system of the example embodiment with ten guard tones, 20 bits can be selected from the 250 discarded bits and mapped onto the 10 guard tones. An illustrative sequence for transmitting the twenty bits in the present transmission mode is described presently in connection with FIG. 6, which shows the puncturing mechanism in accordance with an example embodiment.

Fifteen information bits 601, corresponding to 5 blocks, are encoded by a rate 3/4 coder to provide 45 coded bits 602. Of the 45 coded bits, 20 bits 603 will be transmitted on data sub-carriers. Of the bits 602, two bits 604 (A₁₃ and B₁₄) are selected for transmission on the guard sub-carriers. By repeating this process 10 times, 200 bits and 20 bits are generated to be transmitted on the 100 data sub-carriers and 10 guard sub-carriers, respectively, in each OFDM symbol. At the receiver, data from the guard tones is used in the main de-puncturer instead of null bits for the two bits (A₁₃ and B₁₄). It is emphasized that this pattern is merely illustrative and that other patterns may be used to select bits to be transmitted on the guard tones.

As noted previously, the methods and apparati of the example embodiments make use of guard tones that are normally not used for transmission of coded data in an effort to improve the reliability of data transmission in UWB wireless systems. FIGS. 7-9 illustrate certain performance improvements realized using the methods and apparati of the example embodiments.

FIG. 7 is a graphical representation of the performance of the standard 200 Mbps mode and the 200 Mbps mode COFDM communication according to an example embodiment. It can be observed that the method of the example embodiment provides a gain of about 0.5 dB compared to the standard system. Notably, 0.4 dB of the increase is due to an increase in energy and 0.1 dB is due to coding.

Similarly, FIG. 8 is a graphical comparison of the performance of the known 200 Mbps mode and that of the 200 Mbps of an example embodiment in a multipath channel (CM1). In this case too, the communication system of an example embodiment provides a gain of about 0.5 dB.

FIG. 9 is a graphical comparison of the performance of the original 480 Mbps mode and the 480 Mbps mode of an example embodiment in multipath channel CM1. For the 480 Mbps mode, there is a gain of about 1.4 dB when guard tones are used to carry the punctured coded data.

In view of this disclosure it is noted that the various methods and devices described herein can be implemented in hardware and software. Further, the various methods and parameters are included by way of example only and not in any limiting sense. In view of this disclosure, those skilled in the art can implement the various example devices and methods in determining their own techniques and needed equipment to effect these techniques, while remaining within the scope of the appended claims.

1. A method of transmitting data, the method comprising:
coding an information bit into a plurality of coded bits;
puncturing a select number of the coded bits and removing the select number of bits from a data path;
mapping at least one of the removed coded bits onto respective guard tones; and
transmitting the guard tones.

2. A method as recited in claim 1, wherein the coding is convolutional coding.

3. A method as recited in claim 1, further comprising:
mapping coded bits that are not discarded onto data sub-carriers and transmitting the data sub-carriers along with the guard tones.

4. A method as recited in claim 1, further comprising:
receiving the guard tones and decoding the at least one removed coded bit.

5. A method as recited in claim 1, further comprising:
receiving the guard tones and not decoding the at least one removed coded bit.

6. A method as recited in claim 1, further comprising:
multiplexing a plurality of information bits by coded orthogonal frequency division multiplexing (COFDM).

7. A method as recited in claim 4, further comprising reconstructing received data using the decoded bits.

8. A method as recited in claim 1, further comprising, before the transmitting, modulating the select number of coded bits by quadrature phase shift keying (QPSK) modulation.

9. A method as recited in claim 1, interleaving the at least one removed coded bit before the transmitting.

10. A method as recited in claim 4, further comprising deinterleaving the at least one removed coded bit after the receiving.

11. An apparatus adapted to transmit data, comprising:
a coder adapted to code an information bit into a plurality of coded bits;
a puncturer adapted to receive the plurality of coded bits and to remove a select number of the coded bits from a data path;
a bit selector adapted to select a group of the select number of the coded bits;
a mapping device adapted to map each bit or a plurality of bits from the group of bits onto a respective guard tone.

12. An apparatus as recited in claim 11, wherein the coder is a convolutional coder.

13. An apparatus as recited in claim 11, wherein the apparatus is a wireless device.

14. An apparatus as recited in claim 11, wherein the mapping device is adapted to map each bit or a plurality of bits that is not removed onto a data sub-carrier for transmission.

15. An apparatus as recited in claim 14, further comprising a receiver adapted to receive the bits from the data sub-carrier and the bits from the guard tones.

16. An apparatus as recited in claim 14, further comprising a receiver adapted to receive the bits from the data sub-carrier and but not the bits from the guard tones.

17. An apparatus as recited in claim 14, wherein the receiver further comprises a decoder that decodes the bits from the respective guard tones to improve the receiver performance.

18. A wireless communication system, comprising:
a transmitter, comprising:
a coder adapted to code an information bit into a plurality of coded bits;
a puncturer adapted to receive the plurality of coded bits and to remove a select number of the coded bits from a data path;
a bit selector adapted to select a group of the select number of the coded bits;
a mapping device adapted to map each bit or a plurality of bits from the group of bits to a respective guard tone; and
a receiver adapted to receive bits from a data sub-carrier and the bits from the guard tones, wherein the receiver includes a depuncturer that selects at least one of the bits from the guard tones and provides the at least one bit to another depuncturer.

19. A wireless communication system as recited in claim 18, wherein the wireless system is a coded orthogonal frequency division multiplexing (COFDM) system.

20. A wireless communication as recited in claim 18, wherein the receiver further comprises a convolutional decoder.
